(19) United States
(12) Patent Application Publication
(10) Pub. No.: US 2025/0058634 A1
(43) Pub. Date: Feb. 20, 2025

(54) POWER SUPPLY SYSTEM FOR VEHICLES

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/631,403

(22) Filed: Apr. 10, 2024

(30) Foreign Application Priority Data
Apr. 10, 2023 (JP) 2023-063146

(51) Int. Cl. B60L 1/00; B60L 53/51; H02J 7/35

(52) U.S. Cl. CPC B60L 1/00; B60L 53/51; H02J 7/35; H02J 2310/48

(57) ABSTRACT

A vehicle power supply system supplies electric power generated by a solar panel to an auxiliary unit, and supplies electric power from a drive battery to the auxiliary unit, and switches between ON and OFF of connection between the drive battery and the auxiliary unit by a relay. When the number of times the relay has been switched is greater than or equal to a predetermined number of times, the relay is kept ON.

### CROSS REFERENCE TO RELATED APPLICATION

This application claims priority to Japanese Patent Application No. 2023-063146 filed on Apr. 10, 2023, which is incorporated herein by reference in its entirety including the specification, claims, drawings, and abstract.

### TECHNICAL FIELD

The present disclosure relates to a vehicle power supply system that supplies electric power from a solar panel or a drive battery to an auxiliary unit.

### BACKGROUND

Some vehicle power supply systems supply power from a solar panel or a drive battery to an auxiliary unit. The auxiliary unit includes an auxiliary battery and an auxiliary system such as an electrical component. For example, Japanese Patent No. 667161 discloses a vehicle power supply system in which electric power is supplied from a solar panel or a drive battery to an auxiliary device, and a relay is provided between the drive battery and the auxiliary device battery.

### SUMMARY

In the vehicle power supply system disclosed in Japanese Patent No. 667161, when electric power generated by a solar panel is small, an auxiliary battery is charged from a drive battery. However, when the amount of solar radiation required for power generation by the solar panel is unstable, the number of times of switching ON or OFF of the relay between the drive battery and the auxiliary battery increases, and the life of the relay may be significantly reduced.

Accordingly, an object of the present disclosure is to provide a vehicle power supply system capable of suppressing a decrease in the life of a relay by reducing the number of times the relay is switched ON or OFF.

A vehicle power supply system according to the present disclosure, supplies electric power from a drive battery to the auxiliary unit, and supplies electric power from a drive battery to the auxiliary unit, and switches between ON and OFF of connection between the drive battery and the auxiliary unit by a relay. When the number of times the relay has been switched is greater than or equal to a predetermined number of times, the relay is kept ON.

According to the above configuration, it is possible to suppress a decrease in the life of the relay by reducing the number of times of switching ON or OFF of the relay.

A vehicle power supply system according to the present disclosure, when power consumption of the drive battery is to be suppressed and power generated by the solar panel can be supplied to the auxiliary unit, the relay is turned OFF.

According to the above configuration, it is possible to suppress power consumption of the drive battery by ensuring a charging opportunity by power generation of the solar panel.

According to the vehicle power supply system of the present disclosure, it is possible to suppress a decrease in the life of the relay by reducing the number of times the relay is switched ON or OFF.

### BRIEF DESCRIPTION OF DRAWINGS

FIG. 1 is a block diagram showing a configuration of a vehicle power supply system according to an embodiment of the present disclosure.

FIG. 2 is a block diagram showing a configuration of a power supply ECU.

FIG. 3 is a flowchart showing a flow of charging control.

### DESCRIPTION OF EMBODIMENTS

Hereinafter, an example of an embodiment of the present disclosure will be described in detail. In the following description, specific shapes, materials, directions, numerical values, and the like are examples for facilitating understanding of the present disclosure, and can be appropriately changed according to applications, purposes, specifications, and the like.

### Vehicle Power Supply System

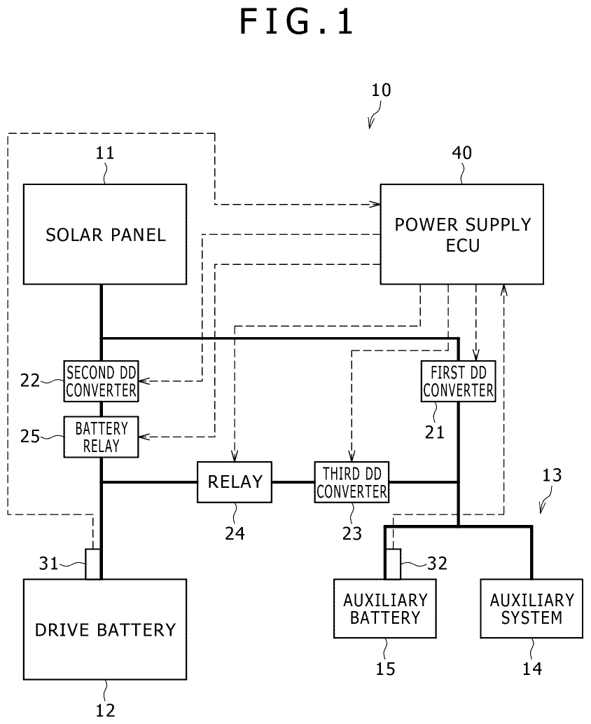

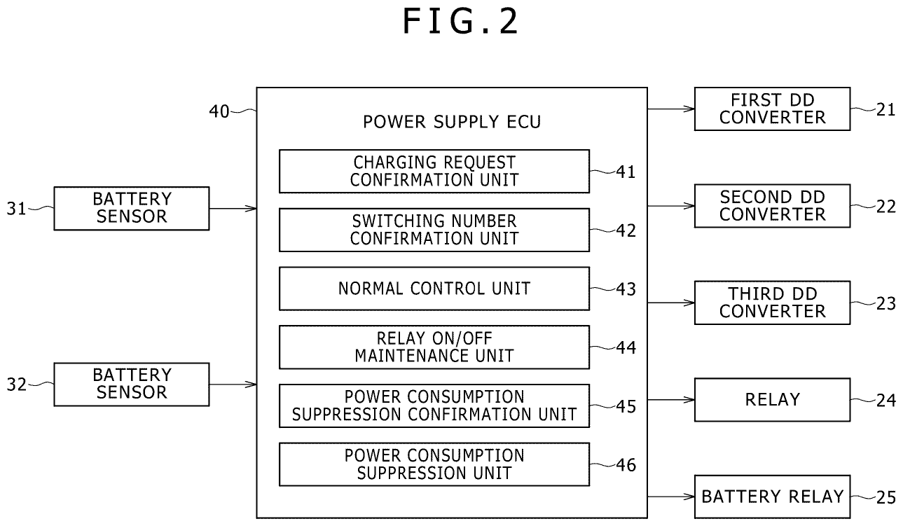

A vehicle power supply system 10 will be described with reference to FIGS. 1 and 2.

The vehicle power supply system 10 is mounted on a vehicle, supplies electric power generated by the solar panel 11 to the auxiliary unit 13, supplies electric power from the drive battery 12 to the auxiliary unit 13, and switches between ON and OFF of the connection between the drive battery 12 and the auxiliary unit 13 by the relay 24. According to the vehicle power supply system 10, although details will be described later, it is possible to suppress a decrease in the lifespan of the relay 24 by reducing the number of times of switching between ON and OFF of the relay 24.

The vehicle is a BEV (Battery Electric Vehicle) that runs by driving a motor (not shown) using only power of a battery for running. However, the vehicle of the present disclosure may be a hybrid electric vehicle (HEV) that travels by driving a gasoline engine and a motor.

The solar panel 11 is a solar power generation device that generates power using sunlight or solar heat, and is provided in a vehicle roof or the like that easily receives sunlight in a vehicle. A first DD converter 21 that converts the power generated by the solar panel 11 into a predetermined voltage is provided between the solar panel 11 and the auxiliary unit 13. A second DD converter 22 that converts the power generated by the solar panel 11 into a predetermined voltage and a battery relay 25 that switches between ON and OFF of the connection between the solar panel 11 and the drive battery 12 are provided between the solar panel 11 and the drive battery 12.

The drive battery 12 supplies electric power to a motor that drives the vehicle. As the drive battery 12, a lithium ion battery may be used. Between the drive battery 12 and the auxiliary unit 13, a third DD converter 23 for converting the voltage of the drive battery 12 into a predetermined voltage and a relay 24 for switching between ON and OFF of the connection between the solar panel 11 and the drive battery 12 are provided. The drive battery 12 is provided with a battery sensor 31. The battery sensor 31 detects a voltage, a charge-side current, or a discharge-side current of the drive battery 12.

The auxiliary unit 13 includes an auxiliary system 14 and an auxiliary battery 15. The auxiliary system 14 is a device that consumes electric power, such as electric components in the vehicle, a control device that controls the electric components, a control device related to traveling, and a control device that controls automatic driving. The auxiliary battery 15 supplies electric power to the auxiliary system 14. The auxiliary battery 15 is a battery having a lower voltage and a smaller capacity than the drive battery 12 described above. As the auxiliary battery 15, a lead battery, a lithium ion battery may be used. The auxiliary battery 15 is provided with a battery sensor 32. The battery sensor 32 detects a voltage, a charging current, or a discharging current of the auxiliary battery 15.

The power supply ECU 40 controls each device so as to supply electric power from the solar panel 11 or the drive battery 12 to the auxiliary unit 13. In addition, the power supply ECU 40, which will be described in detail later, executes charging control to charge the auxiliary battery 15 from the drive battery 12 when the electric power generated by the solar panel 11 is small.

The power supply ECU 40 includes a CPU (Central Processing Unit) serving as an arithmetic processing unit, and a storage unit such as a RAM (Random Access Memory) and a ROM (Read Only Memory), and performs signal processing in accordance with a program stored in advance in the ROM while using a temporary storage function of the RAM.

The power supply ECU 40 is connected to the first DD converter 21, the second DD converter 22, and the third DD converter 23. The power supply ECU 40 controls the outputs of the first DD converter 21, the second DD converter 22, and the third DD converter 23. The relay 24 and the battery relay 25 are connected to the power supply ECU 40. The power supply ECU 40 switches between ON and OFF of the relay 24 and the battery relay 25.

The battery sensor 31 is connected to the power supply ECU 40. The power supply ECU 40 acquires the voltage, the charging current, or the discharging current of the drive battery 12 detected by the battery sensor 31. The battery sensor 32 is connected to the power supply ECU 40. The power supply ECU 40 acquires the voltage, the charging current, or the discharging current of the auxiliary battery 15 detected by the battery sensor 32.

The power supply ECU 40 includes a charging request confirmation unit 41, a switching number confirmation unit 42, a normal control unit 43, a relay ON/OFF maintenance unit 44, a power consumption suppression confirmation unit 45, and a power consumption suppression unit 46, which will be described in detail later. The charging request confirmation unit 41, the switching number confirmation unit 42, the normal control unit 43, the relay ON/OFF maintaining unit 44, the power consumption suppression confirmation unit 45, and the power consumption suppression unit 46 are realized by the CPU executing a program stored in the ROM or the RAM.

The charging request confirmation unit 41 confirms whether or not there is a charging request. The charging is to charge the auxiliary battery 15 from the drive battery 12 when the electric power generated by the solar panel 11 is small in the vehicle power supply system 10. The charging may be requested, for example, when the charging rate of the auxiliary battery 15 is equal to or less than a predetermined charging rate. The predetermined charging rate may be stored in the storage unit in advance. The charging rate of the auxiliary battery 15 may be calculated from the voltage of the auxiliary battery 15 and the discharge-side current. The charging may be requested when the voltage of the auxiliary battery 15 is equal to or lower than a predetermined voltage, for example. The predetermined voltage may be stored in the storage unit in advance.

When the charging request is confirmed by the charging request confirming unit 41, the switching number confirming unit 42 confirms whether the switching number of the ON or OFF of the relay 24 up to the present is equal to or less than the reference number. The reference number of times is a number of times when the relay 24 exceeds the reference number of times, and is stored in the storage unit in advance.

The normal control unit 43 executes normal control of turning ON the relay 24 after completion of charging from the drive battery 12 to the auxiliary battery 15.

After the completion of the charging from the drive battery 12 to the auxiliary battery 15, the relay ON/OFF maintaining unit 44 keeps the relay 24 ON.

Here, in the vehicle power supply system 10, when the amount of solar radiation necessary for power generation of the solar panel 11 is unstable, the number of times of switching between ON and OFF of the relay 24 increases, and the life of the relay 24 may decrease. As a countermeasure against this, when the relay 24 having a large number of times of endurance switching is selected, there is a concern that the part size and cost of the relay 24 increase.

Therefore, according to the relay ON/OFF maintaining unit 44, by keeping the relay 24 ON even when the charging of the auxiliary unit 13 is completed, the number of times of switching ON or OFF of the relay 24 can be reduced, and a decrease in the life of the relay 24 can be suppressed.

The power consumption suppression confirming unit 45 confirms whether to suppress the power consumption of the drive battery 12. The power consumption of the drive battery 12 may be suppressed when the charging rate of the drive battery 12 is equal to or less than a predetermined charging rate, for example. The predetermined charging rate may be stored in the storage unit in advance. The charging rate of the drive battery 12 may be calculated from the voltage of the drive battery 12 and the discharge-side current. Whether to suppress the power consumption of the drive battery 12 may be required, for example, when the voltage of the drive battery 12 is equal to or lower than a predetermined voltage. The predetermined voltage may be stored in the storage unit in advance.

When the solar panel 11 is capable of generating power, the power consumption suppressing unit 46 turns off the relay 24. The case where power generation by the solar panel 11 is possible may be a case where it is estimated that power generation by the solar panel 11 is possible in the current time period based on the history of power generation by the solar panel 11.

Here, when the relay 24 is maintained in the ON state by the relay ON maintaining unit 44, the power of the drive battery 12 is consumed by the power consumption of the relay 24 maintained in the OFF state. Therefore, according to the power consumption suppressing unit 46, it is possible to suppress the power consumption of the drive battery 12 by ensuring the charging opportunity by the power generation of the solar panel 11.

When the charging rate of the auxiliary battery 15 is equal to or higher than the predetermined charging rate, the power consumption suppressing unit 46 may turn off the relay 24. The predetermined charging rate is stored in the storage unit in advance. As a result, the time during which power can be supplied from the auxiliary battery 15 to the auxiliary system 14 becomes long, the time until the next charging request is generated becomes long, the time until the next relay 24 is turned ON becomes long, and the number of times the relay 24 is turned ON or OFF can be reduced.

The power consumption suppressing unit 46 may stop a part of the function of the auxiliary system 14 during parking. The function of the auxiliary device system 14 during parking may be, for example, recording by a drive recorder, a warning function when a mobile phone is forgotten in the vehicle, a security function of the vehicle, or the like. As a result, the power consumption of the auxiliary system 14 is reduced, and the number of times the relay 24 is turned ON or OFF can be reduced.

### Charging Control

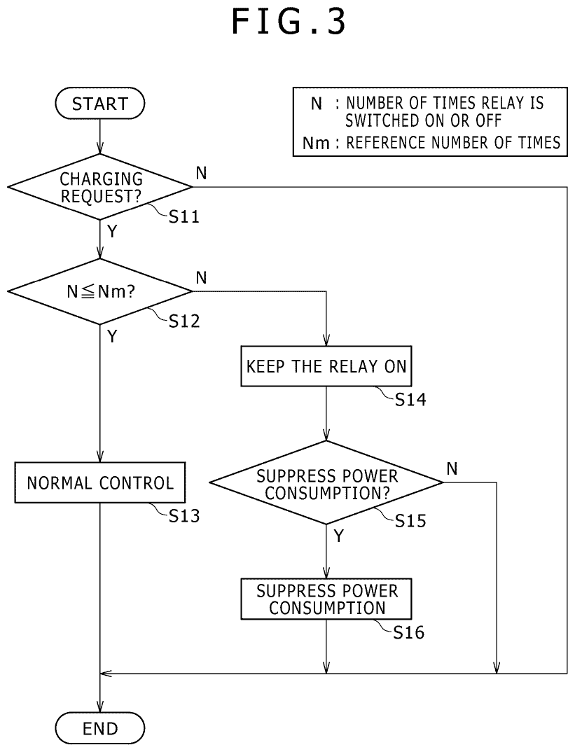

The flow of the charging control will be described with reference to FIG. 3.

In the charging control, the auxiliary unit 13 is charged with electric power from the drive battery 12 based on each function of the power supply ECU 40 described above in accordance with the following procedure. In step S11, the charging request confirmation unit 41 confirms whether there is a charging request. When there is a request for charging, the process proceeds to step S12.

In step S12, the number-of-switchings confirming unit 42 confirms whether or not the number of switchings of ON or OFF of the relay 24 up to the present time is equal to or less than the reference number of times. If the number of times the relay 24 is switched ON or OFF is equal to or less than the reference number of times, the process proceeds to step S13. If the number of times the relay 24 is switched ON or OFF is greater than the reference number of times, the process proceeds to step S14.

In step S13, the normal control unit 43 executes normal control of turning ON the relay 24 after completion of charging from the drive battery 12 to the auxiliary battery 15.

In step S14, after the completion of the charging from the drive battery 12 to the auxiliary battery 15, the relay ON maintaining unit 44 keeps the relay 24 ON. As a result, it is possible to suppress a decrease in the life of the relay 24 by reducing the number of times of switching ON or OFF of the relay 24.

In step S15, the power consumption suppression confirming unit 45 confirms whether to suppress the power consumption of the drive battery 12. When the power consumption of the drive battery 12 is suppressed, the process proceeds to step S16.

In step S16, for example, when the solar panel 11 is capable of generating power, the relay 24 is turned ON by the power consumption suppressing unit 46. Accordingly, it is possible to suppress power consumption of the drive battery 12 by securing a charging opportunity by power generation of the solar panel 11.

Note that the present disclosure is not limited to the above-described embodiments and modifications thereof, and it is needless to say that various modifications and improvements can be made within the scope of the matters described in the claims of the present application.

1. A vehicle power supply system for supplying electric power generated by a solar panel to an auxiliary unit, supplying electric power from a drive battery to the auxiliary unit, and switching between ON and OFF of connection between the drive battery and the auxiliary unit by a relay,
wherein when the number of times the relay has been switched is greater than or equal to a predetermined number of times, the relay is kept ON.

2. The vehicle power supply system according to claim 1,
wherein when power consumption of the drive battery is to be suppressed and power generated by the solar panel can be supplied to the auxiliary unit, the relay is turned OFF.
